(19) United States
(12) Patent Application Publication
(10) Pub. No.: US 2025/0330388 A1
(43) Pub. Date: Oct. 23, 2025

(54) IDENTIFICATION OF UE MOBILITY STATES, AMBIENT CONDITIONS, OR BEHAVIORS BASED ON MACHINE LEARNING AND WIRELESS PHYSICAL CHANNEL CHARACTERISTICS

(71) Applicant: QUALCOMM Incorporated, San Diego, CA (US)

(72) Inventors: Jie MAO, Beijing (CN); Hong YU, Beijing (CN); Tom CHIN, San Diego, CA (US); Nanrun WU, San Diego, CA (US); Wei LI, Beijing (CN); Xinyu WANG, Beijing (CN); Jie ZHU, Beijing (CN)

(21) Appl. No.: 18/845,862

(22) PCT Filed: May 9, 2022
(86) PCT No.: PCT/CN2022/091603

§ 371 Date: Sep. 10, 2024

(51) Int. Cl. H04L 41/16; H04B 17/318

(52) U.S. Cl. CPC H04L 41/16; H04B 17/328

(57) ABSTRACT

A UE may measure a plurality of wireless channel features over a period of time. The UE may train a machine learning model associated with UE mobility state identification based on a wireless channel feature set. The wireless channel feature set may be based on at least one of a training technique associated with the machine learning model, availability of an HST flag, or an RRC state of the UE. The UE may identify a UE mobility state of the UE based on the plurality of wireless channel features and the machine learning model. The machine learning model may include at least one of an LSTM, an RNN, or a transformer. The UE may communicate with a network node based on the identified UE mobility state.

### TECHNICAL FIELD

The present disclosure relates generally to communication systems, and more particularly, to identification of a user equipment (UE) mobility state using machine learning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The apparatus may measure a plurality of wireless channel features over a period of time. The apparatus may train a machine learning model associated with UE mobility state identification based on a wireless channel feature set. The wireless channel feature set may be based on at least one of a training technique associated with the machine learning model, availability of a high speed train (HST) flag, or a radio resource control (RRC) state of the UE. The apparatus may identify a UE mobility state of the UE based on the plurality of wireless channel features and the machine learning model.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates an environment including UEs communicating with different network nodes according to one or more aspects.

FIG. 5 illustrates example measurements of communications in HST cells according to one or more aspects.

FIG. 6 is a diagram of an example neural network processing technique to determine a mobility state of a UE according to one or more aspects.

FIG. 7 is a diagram of an example LSTM cell according to one or more aspects.

FIG. 8 is a diagram of another example LSTM cell according to one or more aspects.

FIG. 9 is a flow diagram of a method of wireless communication according to one or more aspects.

FIG. 10 is a flow diagram of a method of wireless communication according to one or more aspects.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

### DETAILED DESCRIPTION

With the knowledge of the UE mobility state, the UE performance may be improved through application of relevant channel estimation algorithms or signal search procedures, and so on. For example, if the UE is known to be operating on an HST (i.e., the UE mobility state may correspond to an HST mobility state, or an HST state for short), the most suitable channel estimation algorithm and channel control procedure may be different from those suitable for the non-HST state. For example, to speed up the handover procedure, an HST specific channel model for channel estimation may be utilized. Similar to the knowledge of the UE mobility state, knowledge of ambient conditions or behaviors associated with the UE may also help to improve the UE performance. For example, if the UE is known to be moving into or out of the elevator, the signal loss or degradation may be relieved by the UE pre-triggering the signal search procedures.

In some configurations, the UE mobility state or ambient conditions (which may be referred to herein collectively as the UE mobility state) may be based on analysis of the higher layer information. For example, the UE may be assumed to be in the HST state if the UE observes a fast PCI change rate (e.g., a PCI change rate that is greater than a threshold). In another example, the UE may determine that it is in the HST state based on a cell global identity (CGI) table associated with HST network nodes that may be downloaded over the air (OTA).

The techniques for identifying the UE mobility state based on the higher layer information may not have levels of granularity, or may be associated with a limited applicability (i.e., a particular technique may be limited to a particular scenario). In other words, the higher layer information based solution may not be generalized. Further, for the higher layer information based solution, the rich wireless physical channel characteristics may not be exploited for the identification of the UE mobility state, which may represent a wasted opportunity.

However, because the physical wireless channel may change abruptly, it may not be straightforward to make use of the physical wireless channel to infer the UE mobility state based on conventional deduction. In some configurations, the machine learning technique may be utilized in the identification of the UE mobility state in order to take advantage of the rich wireless physical characteristics within a reasonable computation power specification. In particular, the training phase for the machine learning technique may be performed either offline (i.e., training with a fixed set of data that is ingested at once) or online (i.e., training where the data is ingested one observation at a time) with reasonable overhead. Further, the cost for data collection may be close to zero (compared to sensor based machine learning) because the UE modem may already have the physical channel characteristics data during normal communication.

A number of wireless physical channel features may be used to train the machine learning model and to perform UE mobility state detection based on the machine learning model. One or more aspects of the disclosure may relate to selecting suitable wireless physical channel feature sets under different scenarios to achieve an appropriate balance between machine learning model complexity, training overhead, and detection accuracy.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

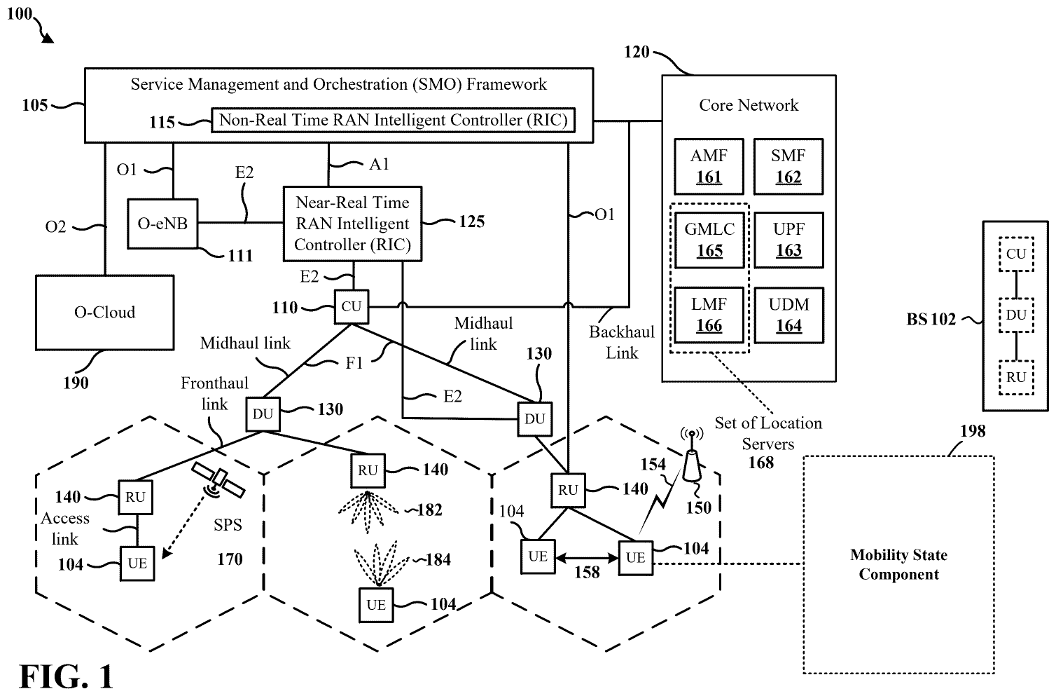

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a mobility state component 198 that may be configured to measure a plurality of wireless channel features over a period of time. The mobility state component 198 may be configured to train a machine learning model associated with UE mobility state identification based on a wireless channel feature set. The wireless channel feature set may be based on at least one of a training technique associated with the machine learning model, availability of an HST flag, or an RRC state of the UE. The mobility state component 198 may be configured to identify a UE mobility state of the UE based on the plurality of wireless channel features and the machine learning model. Although the following description may be focused on 5G NR, the concepts described herein may be applicable to other similar areas, such as LTE, LTE-A, CDMA, GSM, and other wireless technologies.

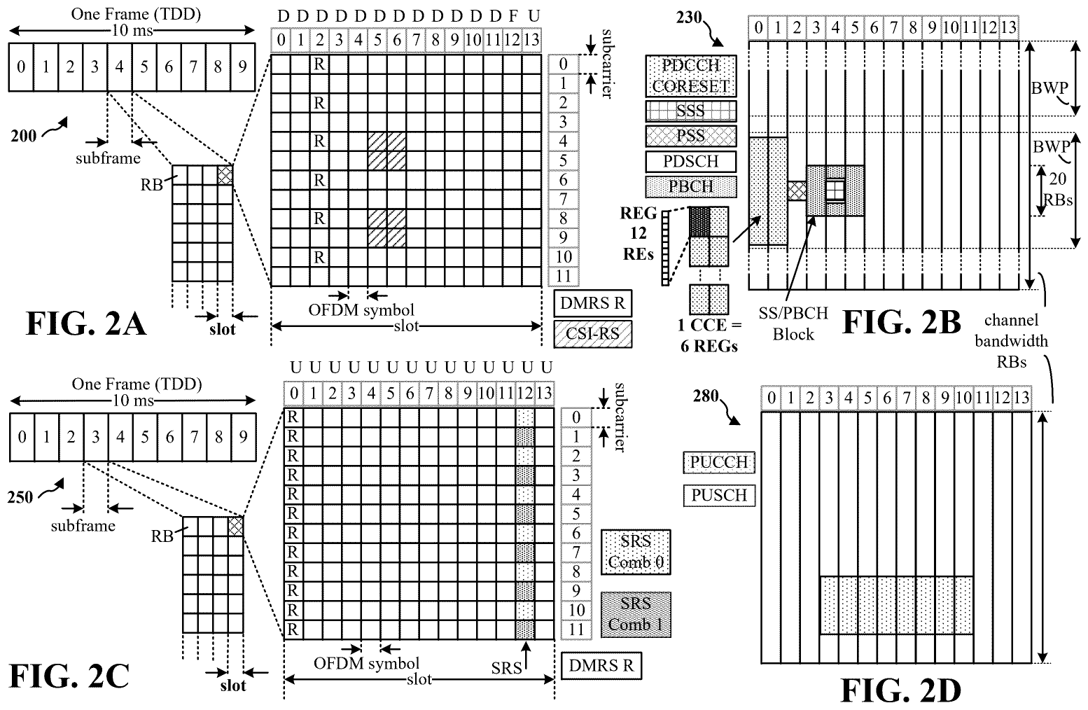

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

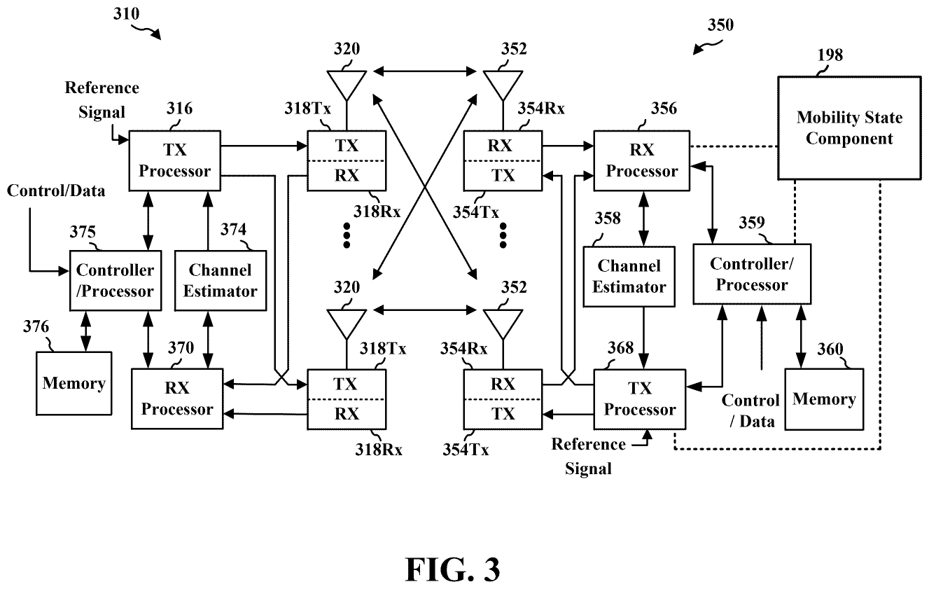

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the mobility state component 198 of FIG. 1.

With the knowledge of the UE mobility state, the UE performance may be improved through application of relevant channel estimation algorithms or signal search procedures, and so on. For example, if the UE is known to be operating on a moving HST (i.e., the UE mobility state may correspond to an HST state), the most suitable channel estimation algorithm and channel control procedure may be different from those suitable for the non-HST state. For example, to speed up the handover procedure, an HST specific channel model for channel estimation may be utilized. Similar to the knowledge of the UE mobility state, knowledge of ambient conditions or behaviors associated with the UE may also help to improve the UE performance. For example, if the UE is known to be moving into or out of the elevator, the signal loss or degradation may be relieved by the UE pre-triggering the signal search procedures.

In some configurations, the UE mobility state or ambient conditions (which may be referred to herein collectively as the UE mobility state) may be based on analysis of the higher layer information. For example, the UE may be assumed to be in the HST state if the UE observes a fast PCI change rate (e.g., a PCI change rate that is greater than a threshold). In another example, the UE may determine that it is in the HST state based on a CGI table associated with HST network nodes that may be downloaded OTA.

The techniques for identifying the UE mobility state based on the higher layer information may not have levels of granularity, or may be associated with a limited applicability (i.e., a particular technique may be limited to a particular scenario). In other words, the higher layer information based solution may not be generalized. Further, for the higher layer information based solution, the rich wireless physical channel characteristics may not be exploited for the identification of the UE mobility state, which may represent a wasted opportunity.

However, because the physical wireless channel may change rapidly or abruptly, it may not be straightforward to make use of the physical wireless channel to infer the UE mobility state based on conventional deduction. In some configurations, the machine learning technique may be utilized in the identification of the UE mobility state in order to take advantage of the rich wireless physical characteristics within a reasonable computation power specification. In particular, the training phase for the machine learning technique may be performed either offline (i.e., training with a fixed set of data that is ingested at once) or online (i.e., training where the data is ingested one observation at a time) with reasonable overhead. Further, the cost for data collection may be close to zero (compared to sensor based machine learning) because the UE modem may already have the physical channel characteristics data during normal communication.

A number of wireless physical channel features may be used to train the machine learning model and to perform UE mobility state detection based on the machine learning model. One or more aspects of the disclosure may relate to selecting suitable wireless physical channel feature sets under different scenarios to achieve an appropriate balance between machine learning model complexity, training overhead, and detection accuracy.

The long short-term memory (LSTM) may be a machine learning algorithm capable of processing a long data sequence without compromising important history information and without error propagation vanishing/explosion (The error backpropagation derivative may be the same for each node in a layer for a recurrent neural network (RNN) because all the weights are the same for each recursion; therefore as the multiplication number increases, if the derivative is less than 1, error propagation vanishing may occur; and if the derivative is greater than 1, error propagation explosion may occur. For the LSTM, the derivative may be different for each node because of the LSTM architecture including the forget gate and the information gate design for the cell state; therefore, the total multiplication of derivatives of each node is less likely to cause error propagation vanishing or explosion). In one or more configurations, the LSTM may be used to identify the UE mobility state because the UE may produce a large amount of time sequence data. Further, the wireless physical channel features usable with the LSTM for the identification of the UE mobility state may include, for example, the reference signal received power (RSRP), the frequency tracking loop total error (which may be referred to hereinafter as the total frequency error), the time advance associated with the network issued command (i.e., the network time advance (NTA)), and the PCI change rate. When the UE is in the HST mobility state, these features may be associated with patterns recognizable based on the machine learning model. For these reasons, the identification of the UE mobility state may be a task suited to the LSTM.

In one or more configurations, the UE may receive the value of the HST flag from the network via a SIB. The reception of the HST flag value may be used to trigger the machine learning process. Further, utilizing the HST flag value in the training of the machine learning model may help to save power. In one configuration, when the HST flag value is not set to be true, the UE may dynamically select the wireless physical channel feature set used in the machine learning model training and the UE mobility state detection at different phases to save power and to improve accuracy.

In one or more configurations, the UE may select a suitable wireless physical channel feature set for online machine learning model training associated with the identification of the UE mobility state.

Unlike in the RRC Connected mode, when the UE is in the RRC Idle mode, some physical channel information such as the NTA may not be available. Further, when the UE is in the RRC Idle mode, the physical channel data generation rate may be lower. Therefore, to make up for the potential performance gap, additional or alternative wireless physical channel features including the Doppler spread and/or the delay spread may be used in the machine learning model training and the UE mobility state detection when the UE is in the RRC Idle mode.

In one or more configurations, in addition to the LSTM, other machine learning models such as the transformer model may also be used for the identification of the UE mobility state. In particular, like the LSTM, the transformer model may also be suitable for features associated with long sequence data. In different aspects, the techniques described herein may be used with 3G, 4G, 5G, 6G, and/or future generation wireless communication systems.

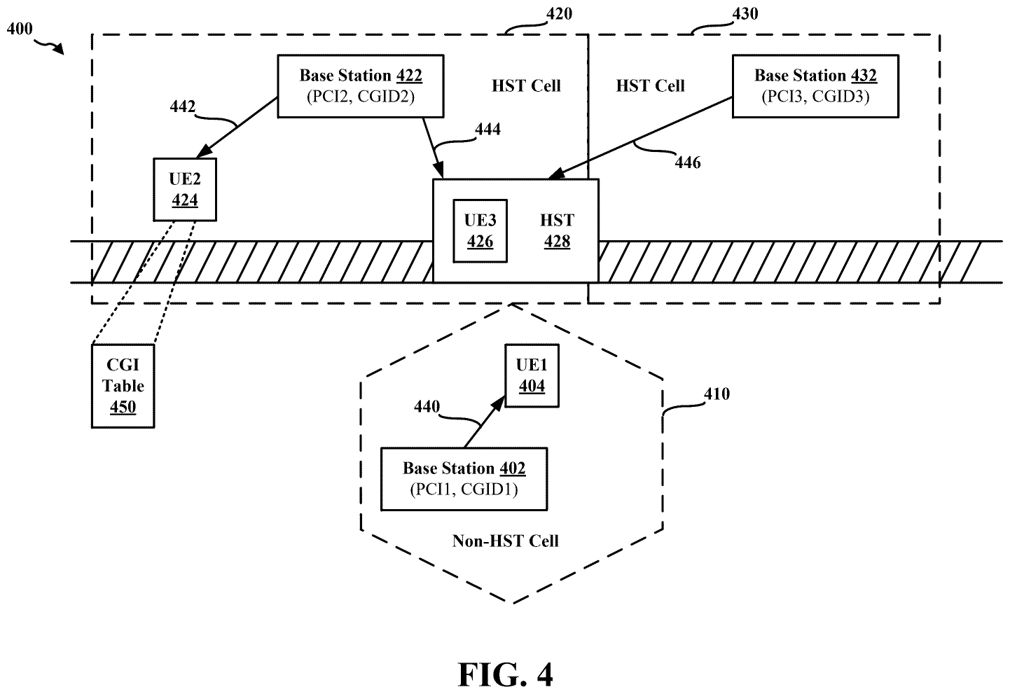

FIG. 4 illustrates an environment 400 including UEs communicating with different network nodes according to one or more aspects. In the illustrated example of FIG. 4, the environment 400 includes a non-HST cell 410 that is served by a non-HST base station 402, a first HST cell 420 that is served by a first HST base station 422, and a second HST cell 430 that is served by a second HST base station 432. The non-HST cell 410 includes a first UE 404 (“UE1”) that is camping on the non-HST cell 410. As shown in FIG. 4, the first HST cell 420 includes a second UE 424 (“UE2”), a third UE 426 (“UE3”), and an HST 428. In the example of FIG. 4, the second UE 424 is located outside of the HST 428, and the third UE 426 is located in the HST 428. The HST 428 may be in a moving state or in a stationary state. Accordingly, the third UE 426 may be associated with a moving state or a stationary state, for example, based on the state of the HST 428.

In the example of FIG. 4, the first UE 404 is located outside the HST 428, is outside the coverage area of the first HST cell 420, and is not camped on the first HST cell 420. The second UE 424 is located outside the HST 428, is located within the coverage area of the first HST cell 420, and is camped on the first HST cell 420. The third UE 426 is located inside the HST 428, is located within the coverage area of the first HST cell 420, and is camped on the first HST cell 420.

As described above, the mobility state (e.g., communication environment or communication scenario) of the UE may impact the performance of the UE. For example, the first UE 404 may apply a signal search procedure, a channel estimation procedure, and/or a control channel decoding procedure that is different than the one applied by the second UE 424 and/or the third UE 426. Additionally, or alternatively, the second UE 424 may apply a signal search procedure, a channel estimation procedure, and/or a control channel decoding procedure that is different than the one applied by the third UE 426. For example, when the HST 428 is in a moving state, the third UE 426 may determine that communications may experience high Doppler effect and, thus, it may be beneficial to apply communication techniques that consider the high Doppler effect. In another example, while the second UE 424 is camping on the first HST cell 420, the second UE 424 may determine that it is moving towards the non-HST cell 410 and, thus, may perform a handover procedure to transition from the first HST cell 420 to the non-HST cell 410. In another example, the third UE 426 may determine that it is moving towards the second HST cell 430 and, thus, may determine to a perform a fast handover procedure to maintain communication when moving from the coverage area of the first HST cell 420 to the coverage area of the second HST cell 430.

Although the non-HST cell 410 is illustrated as having a hexagonal shape and the first HST cell 420 and the second HST cell 430 are illustrated as having a rectangular shape, in other examples, the coverage area associated with the non-HST cell 410, the first HST cell 420, and/or the second HST cell 430 may be associated with a different shape.

In some examples, a UE may determine the mobility state of the UE based on upper layer information in signals received from a network node. The upper layer information may include a PCI and/or a Cell Global identifier (CGID). The network nodes may include the upper layer information with their respective output signals. For example, the first UE 404 may receive a first signal set 440 from the non-HST base station 402, the second UE 424 may receive a second signal set 442 from the first HST base station 422, and the third UE 426 may receive a third signal set 444 from the first HST base station 422 and a fourth signal set 446 from the second HST base station 432. Each of the signal sets may include one or more communications over a time period. Signals of the respective signal sets may include the PCI and/or the CGID associated with the respective network node. For example, one or more signals of the first signal set 440 may include the PCI associated with the non-HST base station 402 (“PCI1”), one or more signals of the second signal set 442 and the third signal set 444 may include the PCI associated with the first HST base station 422 (“PCI2”), and one or more signals associated with the fourth signal set 446 may include the PCI associated with the second HST base station 432 (“PCI3”). In a similar manner, one or more signals of the first signal set 440 may include the CGID associated with the non-HST base station 402 (“CGID1”), one or more signals of the second signal set 442 and the third signal set 444 may include the CGID associated with the first HST base station 422 (“CGID2”), and one or more signals associated with the fourth signal set 446 may include the CGID associated with the second HST base station 432 (“CGID3”).

In some examples, the UE may have the ability to determine it is in an HST state based on a rate of PCI change associated with received signals. For example, based on the signals received by the second UE 424 (e.g., the second signal set 442), the second UE 424 may determine it is in a non-HST state since the PCI stays the same. In contrast, if the rate in PCI change between the signals of the third signal set 444 and the fourth signal set 446 is greater than a threshold, then the third UE 426 may determine it is in an HST state. However, in some examples, an HST cell may apply a remote RF header in communications. The remote RF header may include a PCI and may be the same across different HST cells. For example, one or more HST base stations, such as the first HST base station 422 and the second HST base station 432, may include the same PCI in their upper layer information. In such scenarios, the rate of PCI change measured by a UE may not satisfy the threshold to determine that the UE is in an HST state.

In some examples, the UE may be configured with a CGI table including network nodes associated with HST network nodes. For example, the second UE 424 of FIG. 4 includes a CGI table 450 that includes the CGID associated with HST network nodes, such as the first HST base station 422 (“CGID2”) and/or the second HST base station 432 (“CGID3”). Although the example of FIG. 4 illustrates the second UE 424 including the CGI table 450, in other examples, any of the UEs in a wireless communications system may include and/or access a CGI table. In some examples, the UEs may be configured with the CGI table OTA. In some examples, the UE may determine when it is connected to an HST cell when an identifier of the network node is included in the CGI table. For example, based on the CGID included in the second signal set 442 and the CGI table 450, the second UE 424 may determine it is connected to an HST cell (e.g., the first HST cell 420). However, if the UE is connected to the HST cell and not located on the HST, such as the second UE 424, the UE may incorrectly determine it is in a moving state, for example, based on the moving state of the HST 428.

Thus, the examples using upper layer information (e.g., a PCI, a CGI table, etc.) to determine the mobility state of the UE may incorrectly determine the mobility state, or the upper layer information may be applicable to a specific scenario. That is, a UE using upper layer information to determine the mobility state of the UE may be applicable to a specific scenario and not generally applicable. Additionally, the use of the upper layer information may be unable to exploit the characteristics of the wireless physical channel. For example, metrics associated with signals may exhibit patterns based on the mobility state of the UE. Moreover, as the wireless physical channel may change abruptly, for example, when the HST 428 is in the moving state, the UE may be unable to correctly determine the mobility state of the UE.

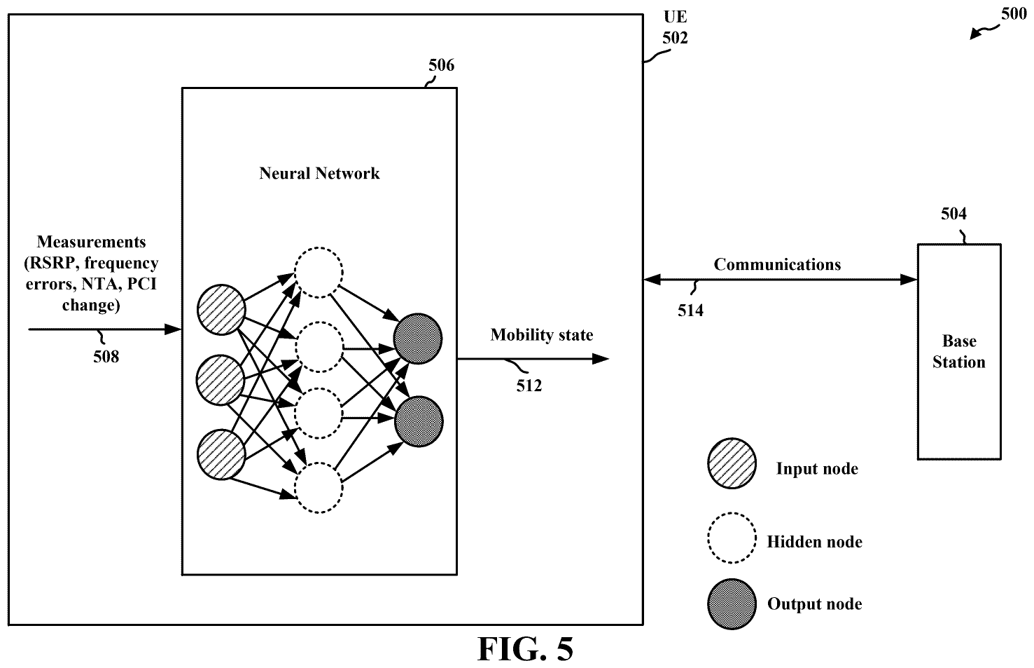

FIG. 5 illustrates a diagram 500 of a UE 502 that includes a neural network 506 configured to determine a mobility state 512 of the UE 502. The mobility state 512 of the UE may be used by the UE 502 for communications 514 with a base station 504.

Among others, examples of machine learning models or neural networks that may be included in the UE 502 include artificial neural networks (ANN), such as a recurrent neural network (RNN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution AxB operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, for example, including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning or reinforcement learning. During training, the machine learning model may be provided with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processing for training the machine learning model. FIG. 5 illustrates that the example neural network 506 may include a network of interconnected nodes. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network 506 may include any number of nodes and any type of connections between nodes. The neural network 506 may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse layers multiple times.

As described above, in a wireless communication environment, communications between a base station and a UE may be associated with different characteristics. For some characteristics, the UE may have the ability to determine that the UE is camping on an HST cell and that the UE is located on an HST (e.g., as described in connection with the third UE 426 of FIG. 4). For other characteristics, the UE may have the ability to determine that the UE is camping on an HST cell and that the UE is not located on an HST (e.g., as described in connection with the second UE 424 of FIG. 4). The UE may use the mobility state of the UE to determine a procedure to apply when communicating with the base station.

In aspects disclosed herein, over time, the UE may utilize a neural network to learn characteristics of measurements associated with mobility states. The UE may then communicate with the base station based on a mobility state 512.

As disclosed herein, a machine learning component or a neural network may be trained over time using measurements 508 performed on one or more communications received over a time period. The measurements 508 may include measured RSRPs, measured frequency errors, such as Frequency Tracking Loop errors, measured time advances associated with NTAs, and/or measured rates of PCI change. The measurements 508 may provide a continual time series data stream or time sequence data. Additionally, the mobility state 512 may be determined to improve communication with the base station 504.

For example, the UE may perform a handover procedure when the mobility state indicates that the UE is camping on an HST cell and not located on an HST (e.g., as described in connection with the second UE 424 of FIG. 4), and the UE may perform a fast handover procedure when the mobility state indicates that the UE is camping on an HST cell and located on an HST (e.g., as described in connection with the third UE 426 of FIG. 4). As another example, the UE may perform a first channel estimation procedure when the mobility state indicates that the UE is camping on an HST cell and not located on an HST (e.g., as described in connection with the second UE 424 of FIG. 4), and the UE may perform a second channel estimation procedure when the mobility state indicates that the UE is camping on an HST cell and located on an HST (e.g., as described in connection with the third UE 426 of FIG. 4). As another example, the UE may perform a first control channel decoding procedure when the mobility state indicates that the UE is camping on an HST cell and not located on an HST (e.g., as described in connection with the second UE 424 of FIG. 4), and the UE may perform a second control channel decoding procedure when the mobility state indicates that the UE is camping on an HST cell and located on an HST (e.g., as described in connection with the third UE 426 of FIG. 4).

Thus, the UE 502 may utilize a neural network to learn over time an improved determination of a mobility state 512 of the UE. Machine learning may be performed at the UE 502 to execute training procedures based on the measurements 508 performed on communications received over a time period. Such training procedures may provide an improved/modified determination of a mobility state 512 to be used for applying a communication procedure (e.g., a handover procedure, a channel estimation procedure, a control channel decoding procedure, etc.) to the communications 514 with the base station.

The UE 502 may determine the mobility state 512 to be used for determining the communication procedure at an increased level of granularity via machine learning. For example, the UE 502 may determine the mobility state 512 based on abrupt changes in characteristics associated with the measurements 508.

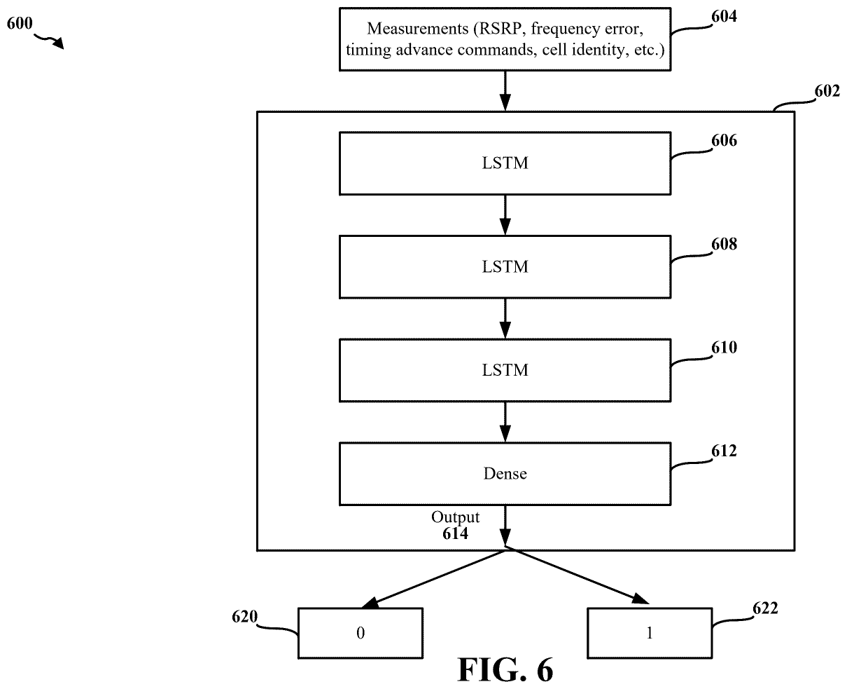

FIG. 6 is a diagram 600 of an example neural network processing technique to determine a mobility state of a UE according to one or more aspects. In the example of FIG. 6, the neural network processing technique includes a neural network 602 employing an LSTM architecture. Aspects of the neural network 602 may be implemented by the neural network 506 of FIG. 5.

As shown in FIG. 6, the neural network 602 receives measurements 604. The measurements 604 may include RSRP, frequency error, timing advance commands (e.g., time advances associated with NTAs), cell identities, etc., as described in connection with the measurements 508 of FIG. 5. The measurements 604 may be associated with different characteristics based on the mobility state of the UE. In some examples, the measurements 604 may include a time sequence of measurements. For example, the measurements 604 may be performed on one or more signals received over a time period.

In the example of FIG. 6, the neural network 602 includes a plurality of layers. Each of the layers employ an LSTM architecture. The LSTM architecture is a machine learning model that is advantageous to use when processing a long time sequence of data. As shown in FIG. 6, the neural network 602 includes a first LSTM layer 606, a second LSTM layer 608, and a third LSTM layer 610. The first LSTM layer 606, the second LSTM layer 608, and the third LSTM layer 610 may be associated with different instances of the LSTM architecture on data (e.g., a same batch of data, such as the measurements 604).

As shown in FIG. 6, the neural network 602 includes a dense layer 612. The dense layer 612 may be a fully connected layer, as described in connection with FIG. 5. The dense layer 612 may be used to convert a larger number of dimensional inputs to an output 614 that is a smaller dimensional output. For example, the dense layer 612 may convert an 8-dimensional input to a 2-dimensional output (e.g., “0” or “1”). With respect to HST, the output 614 of the dense layer 612 may be a first value 620 (“0”) to indicate that the UE is in a non-HST state. The output 614 of the dense layer 612 may be second value 622 (“1”) to indicate that the UE is in in an HST state.

Although the example neural network 602 of FIG. 6 includes three example LSTM layers, other examples may include other suitable quantities of LSTM layers.

Although the output 614 of the neural network 602 of FIG. 6 indicates an HST state or non-HST state of the UE, in other examples, the output of the neural network may indicate additional or alternate states. For example, the output may indicate whether the UE is in an elevator state or a non-elevator state. In another example, the output may indicate whether the UE is in a moving state or a stationary state.

In some examples, the weights associated with the neural network 602 may be adjusted based on the type of output. For example, a first instance of the neural network 602 may include first weights to facilitate determining the HST state of the UE, a second instance of the neural network 602 may include second weights to facilitate determining the elevator state of the UE, a third instance of the neural network 602 may include third weights to facilitate determining a moving or stationary state of the UE, etc.

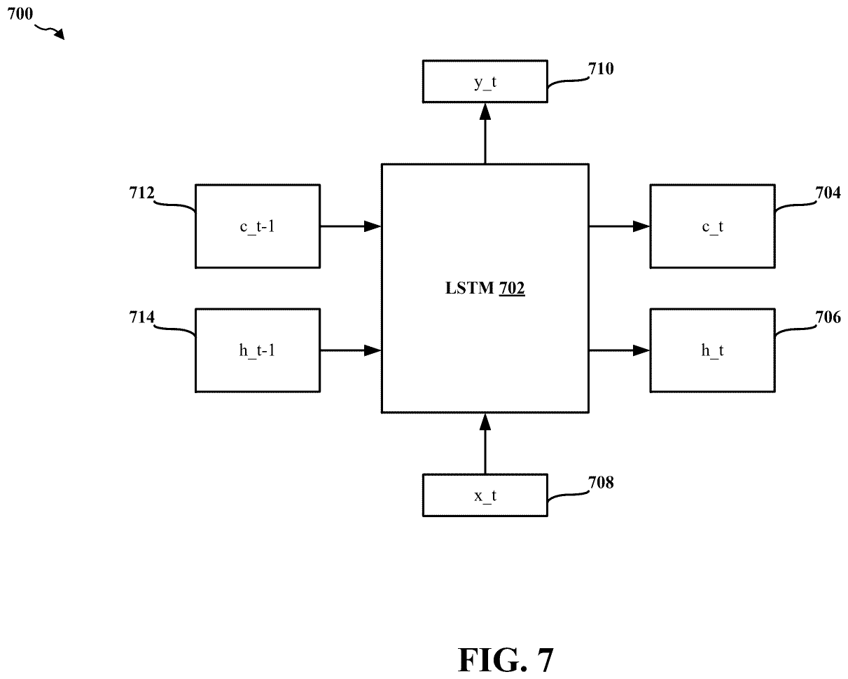

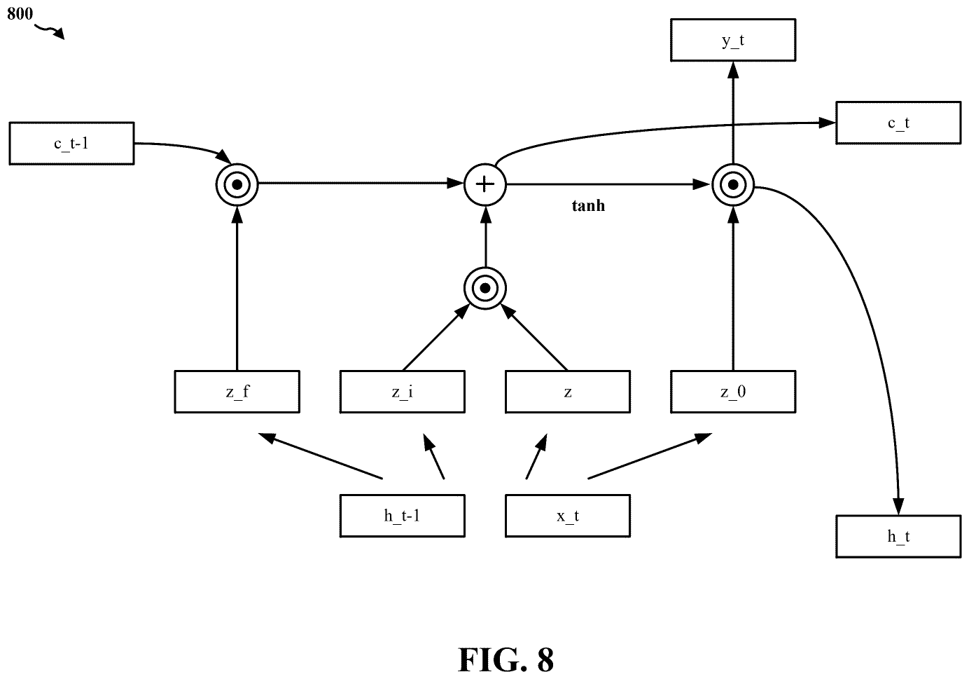

FIG. 7 and FIG. 8 illustrate examples of an LSTM cell. FIG. 7 is a diagram 700 of an example LSTM cell 702 according to one or more aspects. LSTM is a variant of RNN, which includes a cell state 704 (cₜ). The cell state 704 may correspond to long history memory. A previous cell state 712 (cₜ₋₁) corresponds to the value of the long history memory at a previous time. The LSTM cell 702 also includes a hidden state 706 (hₜ) corresponding to short term memory. A previous hidden state 714 (hₜ₋₁) may correspond to the value of the short term memory at a previous time. In the example of FIG. 7, new information 708 (xₜ) is input for the current step. Additionally, output 710 (yₜ) is the output desired for the LSTM cell 702. In some examples, the output 710 may correspond to the output 614 of FIG. 6.

In examples of multiple-input and single-output scenarios, the output 710 may be interpreted as a categorization. For example, the output 710 may correspond to a categorization of UE mobility, such as whether the UE is in an HST, whether the UE is in an elevator, whether the UE is in a subway, whether the UE is moving, etc.

The cell state may change slowly when the previous cell state 712 is added by something resulting in the cell state 704.

The hidden state may change faster when the hidden state 706 and the previous hidden state 714 are different.

FIG. 8 is a diagram of another example LSTM cell 800 according to one or more aspects. In the example of FIG. 8, the LSTM includes a cell state (Cₜ) for a long history information transfer and short term memory (hₜ) for selective information memory. The LSTM cell 800 also includes a final output (yₜ). In the example of FIG. 8, the cell state (cₜ) may be defined by equation 1 (below), the short term memory (hₜ) may be defined by equation 2 (below), and the final output (yₜ) may be defined by equation 3 (below).

$${c}^{t} = {z}^{f} ⊙ {c}^{t - 1} + {z}^{i} ⊙ z \qquad Equation 1$$

$${h}^{t} = {z}^{0} ⊙ tanh ( {c}^{t} ) \qquad Equation 2$$

$${y}^{t} = σ ( {W}^{′} {h}^{t} ) \qquad Equation 3$$

In the example of FIG. 8, the term σ represents the logic sigmoid activation function, with a range of [0, 1]. The value “0” may represent that information is blocked and the value “1” may be used to pass information or to activate information.

In the example of FIG. 8, the symbol ⊙ represents the Hadamard product, which means the corresponding elements in a matrix are multiplied. The Hadamard product is a binary operation that takes two matrices of the same dimensions and produces another matrix of the same dimension as the operands. The symbol ⊕ represents the Hadamard addition in which the corresponding elements in the matrices are added.

The internal architecture of the LSTM cell 800 includes three layers (e.g., a forget layer (z_{f}), an information layer (zᵢ) and (z), and an output layer (zₒ)) that regulate relevant information to be transferred and not relevant information to be forgotten. In the example of FIG. 8, the information layer (z) may be defined by equation 4 (below), the information layer (zᵢ) may be defined by equation 5 (below), the forget layer (z_{f}) may be defined by equation 6 (below), and the output layer (zₒ) may be defined by equation 6 (below).

$$z = tanh ( {W}_{{h}^{t - 1}}^{{x}^{t}} ) \qquad Equation 4$$

$${z}^{i} = σ ( {W}_{{h}^{t - 1}}^{{i}^{{x}^{t}}} ) \qquad Equation 5$$

$${z}^{f} = σ ( {W}_{{h}^{t - 1}}^{{f}^{{x}^{t}}} ) \qquad Equation 6$$

$${z}^{o} = σ ( {W}_{{h}^{t - 1}}^{{o}^{{x}^{t}}} ) \qquad Equation 7$$

In Equations 4 to 7, the terms W, Wⁱ, W^{f}, and Wⁱ represent weights coefficients to be converged. When the model is trained, the weights may be configured to output a scenario with relative precision and accuracy.

The forget layer (z_{f}), as defined by Equation 6, is used to forget irrelevant information from previous long history memory (cₜ₋₁). The forget layer (z_{f}), sometimes referred to as a “forget gate,” is based on previous short-term memory (hₜ₋₁) and new input data (xₜ). The information layer (z), as defined by Equation 4, is a hidden layer input that is used to store the new input data (xₜ) and previous short-term memory (hₜ₋₁) with an appropriate weight (w) and is transformed by a tanh function to ensure the output data value is within (−1,1) as the standard data format. The information layer (zᵢ), as defined by Equation 5, is the information gate that regulates what relevant information is stored. The sigmoid function for the information layer (zᵢ) is also based on the previous short-term memory (hₜ₋₁) and the new input data (xₜ), but is modified with a different weight Wⁱ. The output from the forget layer (z_{f}) and the hidden layer (e.g., the information layer (z)) are added to form a new cell state (cₜ).

In the example of FIG. 8, the output layer (zₒ) produces a current hidden state (e.g., a current short term memory (hₜ) for transferring as the short-term memory for the next step. The output layer (zₒ) is based on the current cell state (cₜ) and regulated by the output gate that is controlled by the short-term input of the new input data (xₜ) and the previous short-term memory (hₜ₋₁).

In the example of FIG. 8, the final output (yₜ) is based on the current hidden state (e.g., the current short term memory (hₜ)) with the weighted information (e.g., the weight W′), and is transformed by the sigmoid function for practical usage within the LSTM cell 800.

In one or more configurations, a wireless physical channel feature set may be selected for offline training of the machine learning model. The wireless physical channel feature set for the offline training may include one or more of the serving cell RSRP, the total frequency error, the NTA, the PCI change rate, and so on. In order to achieve an appropriate balance between detection accuracy and model simplicity, in one configuration, the wireless physical channel feature set used for the offline training may include the RSRP and the NTA.

When the UE is operating in a traveling HST, the observed RSRP sequence pattern and the observed NTA sequence pattern may be associated with certain periodicities. The periodicity in the sequence pattern may be detected by the LSTM because the LSTM may be suitable for processing sequence data with history information.

If the UE is camped in an HST network with the HST flag set to be true, but is in a stationary state (e.g., the train is stationary, or the UE is not operating on a train), the sequence pattern of the observed RSRP, NTA, or total frequency error may resemble a flat line, which may also be detected using the LSTM with case.

Furthermore, without network frequency pre-compensation, the total frequency error may also show a periodicity with a large frequency error jump/spike near the middle point between adjacent TX nodes (e.g., base stations) before or after a handover. Accordingly, without network frequency pre-compensation, the total frequency error may be a suitable feature for machine learning model training and the UE mobility state detection using the LSTM. However, because many networks do implement frequency pre-compensation, the total frequency error may be a deprioritized wireless physical channel feature, and may not be used in machine learning model training and the UE mobility state detection in some configurations.

In one or more configurations, a wireless physical channel feature set may be selected for online training of the machine learning model. In order to improve detection accuracy, wireless physical channel features may be added or removed during online training.

In particular, abundant/excessive features in the wireless physical channel feature set may cause overfitting. In an overfitting situation, a UE actually in the HST state may not be able to positively identify the HST state. As a result of the detection error, procedures more suitable for the HST state may not actually be used, which may degrade modem performance. For example, the call drop rate may increase and the handover/reselection failure rate may increase. In one or more configurations, if the UE detects the overfitting situation (e.g., if the UE observes unsatisfactory performance while ostensibly in a non-HST state), the UE may remove some features from the wireless physical channel feature set used in the machine learning model training and the UE mobility state detection. In one configuration, features including the total frequency error and/or the PCI change rate may be removed and features including the RSRP and the NTA may be kept. The total frequency error may be removed from the wireless physical channel feature set because the TX node may implement frequency pre-compensation, and the frequency pre-compensation may remove the characteristic frequency error jump/spike, rendering the total frequency error less effective as a feature for the machine learning model. Moreover, the PCI change rate may be removed from the wireless physical channel feature set because in dense urban environments, the wireless condition may also change dynamically even though the UE is not operating on an HST. For example, the UE may experience handovers frequently in an urban environment, and the PCI change rate may correspondingly be high, even though the UE may not be in an HST mobility state. In other words, including the PCI change rate in the wireless physical channel feature set may cause confusion when the UE is in an urban environment.

On the other hand, insufficient features may cause underfitting. In an underfitting situation, a UE actually not in the HST state may be mistakenly identified as being in the HST state. As a result of the detection error, procedures more suitable for the HST state may be used for the UE that is not actually in the HST state, which may also degrade modem performance. For example, the UE may experience an early (premature) handover to a weak target cell. If the UE detects the underfitting situation (e.g., if the UE observes unsatisfactory performance while ostensibly in an HST state), the UE may add some features to the wireless physical channel feature set used in the machine learning model training and the UE mobility state detection. For example, in addition to features already in use including the NTA and the RSRP, the UE may add features including the total frequency error and/or the PCI change rate to the wireless physical channel feature set. In one configuration, the UE may add the feature pattern associated with a particular situation/UE mobility state into a list of exceptions. Therefore, when the same feature pattern is encountered later, the UE may identify the situation/UE mobility state (e.g., the HST state) based on the list of exceptions.

In one or more configurations, if the HST flag is not set in HST networks (i.e., the HST flag is unavailable), the machine learning model may still be used to identify the UE mobility state including the HST-related UE mobility state. In order to improve detection accuracy and save power, the wireless physical channel feature set and the machine learning model may be simple at the beginning. Using the simple feature set and the simple machine learning model may help to save power. In one configuration, the simple wireless physical channel feature set may include just the RSRP and the PCI change rate. When the HST state is preliminarily identified based on the simple machine learning model, the UE may attempt to verify the preliminary identification result based on a more thorough wireless physical channel feature set (e.g., a feature set similar to the one used with HST flagged data, as described above) and a correspondingly more complex machine learning model. In particular, the more thorough wireless physical channel feature set may include not just the RSRP and the PCI change rate, but also the NTA and the total frequency error. The more thorough wireless physical channel feature set may lead to improved accuracy. Because the more complex machine learning model is trained with HST flagged data, the UE mobility state identification result based on the more complex machine learning model is likely to be correct. If the verification result based on the more thorough wireless physical channel feature set indicates that the UE is in a non-HST mobility state, The UE may revert back to using the simple feature set to train the machine learning model and to perform the UE mobility state identification because the preliminary positive identification of the HST state is likely to be a false alarm. In one or more configurations, a second machine learning model (e.g., the model corresponding to the features set used at 926 for offline training where the HST flag is not available or the basic feature set used at 910, as will be described in further detail below) may be trained either offline or online.

In one or more configurations, even if the HST flag is not set in HST networks (i.e., the HST flag is unavailable), the more complex machine learning model and the more thorough (full or flexible) wireless physical channel feature set (e.g., the machine learning model and the feature set similar to the ones used with HST flagged data, as described above) may be used from the beginning. In one configuration, in order to save power, the machine learning model based UE mobility state detection may be triggered with a larger time interval between every two adjacent detection actions. In other words, the UE mobility state detection based on the machine learning model may be performed with a lower frequency.

When the UE is in the RRC Connected mode, the UE and the network may be in a connected state. Accordingly, the network may issue the NTA. However, when the UE is in the RRC Idle mode, the UE may not be able to receive the NTA. Instead, the data feed interval may depend on the Idle-discontinuous reception (I-DRX) cycle. Therefore, the wireless physical channel feature set used for the RRC Connected mode may not be used in machine learning model training and UE mobility state detection when the UE is in the RRC Idle mode.

In particular, when the UE is in the RRC Connected mode, the UE may obtain the NTA from the network with a sufficiently high regularity (e.g., the data sequence interval may be as small as 20 ms). Accordingly, the rich data information may improve detection accuracy associated with the UE mobility state identification. In one or more configurations, to make up for the detection performance difference between the RRC Idle mode and the RRC Connected mode, when the UE is in the RRC Idle mode, additional features may be added to the wireless physical channel feature used in machine learning model training and UE mobility state detection. The additional features may include the Doppler spread and/or the delay spread measured based on transmissions from multiple network nodes (e.g., TRPs or remote radio heads (RRHs)). The Doppler spread may refer to the widening of the spectrum of a narrow-band signal transmitted through a multipath propagation channel. The Doppler spread may be caused by the different Doppler shift frequencies associated with the multiple propagation paths when there is relative motion between the transmitter and the receiver. Further, the delay spread may refer to the smearing or widening of a short pulse transmitted through a multipath propagation channel. The delay spread may happen because different propagation paths may have different time delays. The additional features may be added when the UE is in the RRC Idle mode because of the data generation rate may be much lower than when the UE is in the RRC Connected mode.

Because the wireless physical channel features utilized may correspond to long sequence data, in addition to the LSTM, other suitable machine learning models may also be used for UE mobility state identification. Example may include the transformers. Transformers may utilize the mechanism of self-attention, differentially weighting the significance of each part of the input data to enable modeling of long dependencies between input sequence elements. However, unlike RNNs, the transformers may not always process the data in order. Rather, the self-attention mechanism may provide the context for any position in the input sequence. This feature of the transformers may allow for more parallelization than would be allowed by RNNs. Accordingly, using the transformers may reduce training time.

The techniques described hereinafter may also be adapted for and applied to future wireless communication technologies such as 6G and beyond. The actual wireless physical channel features used may be different for future technologies. However, the same principles may apply with appropriate adjustments as long as the relevant long sequence data may be collected via physical communication with low overhead.

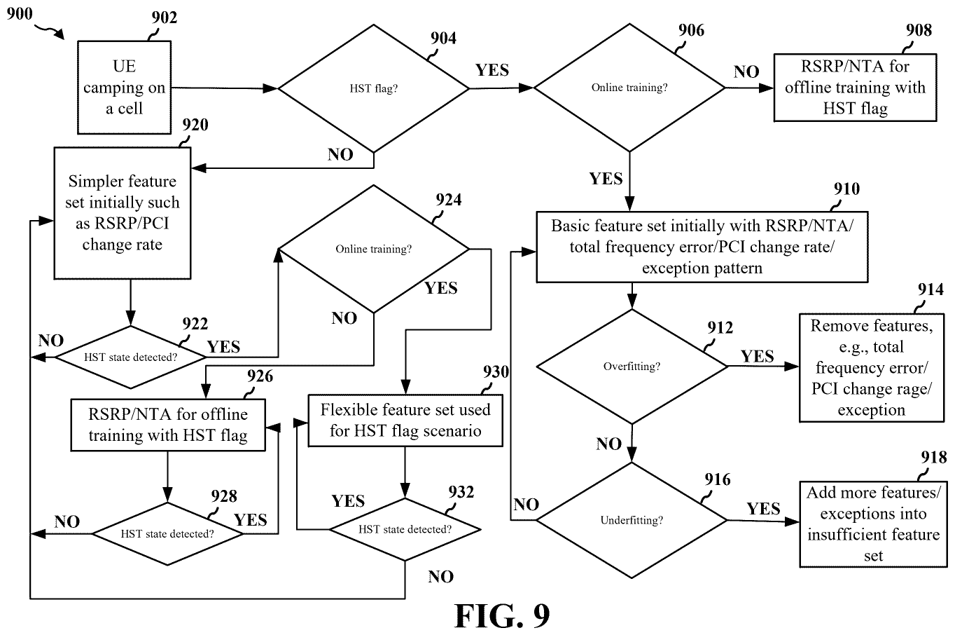

FIG. 9 is a flow diagram 900 of a method of wireless communication according to one or more aspects. Operations in FIG. 9 may be performed by a UE (e.g., the UE 104/350/1002). At 902, the UE may camp on a cell.

At 904, the UE may determine whether an HST flag is available for the cell. If yes, the process may proceed to 906. If no, the process may proceed to 920.

At 906, the UE may determine whether to perform online training. If yes, the process may proceed to 910. If no, the process may proceed to 908.

At 908, the UE may perform offline training of a machine learning model associated with identification of the UE mobility state of the UE based on the wireless physical channel features including the RSRP and/or the NTA. The value of the HST flag may also be used in training the machine learning model. Further, the UE may identify the UE mobility state based on the trained machine learning model.

At 910, the UE may perform online training of a machine learning model associated with identification of the UE mobility state of the UE based on the basic wireless physical channel features and/or an exception pattern, where the basic wireless physical channel features may include one or more of the RSRP, the NTA, the total frequency error, or the PCI change rate. Further, the UE may identify the UE mobility state based on the trained machine learning model.

At 912, the UE may identify whether an overfitting situation has occurred. If yes, the process may proceed to 914. If no, the process may proceed to 916.

At 914, the UE may remove one or more features and/or the exceptions from the wireless physical channel feature set in response to identifying the overfitting situation. The features to be removed may include one or more of the total frequency error or the PCI change rate.

At 916, the UE may identify whether an underfitting situation has occurred. If yes, the process may proceed to 918. If no, the process may return to 910.

At 918, the UE may add one or more features and/or exceptions to the wireless physical channel feature set in response to identifying the underfitting situation.

At 920, the UE may train a simple machine learning model based on a simpler wireless physical channel feature set using offline training. The simpler wireless physical channel feature set may include the RSRP and/or the PCI change rate. Further, the UE may identify the UE mobility state based on the trained simple machine learning model.

At 922, the UE may determine whether the identified UE mobility state corresponds to an HST state. If yes, the process may proceed to 924. If no, the process may return to 920.

At 924, the UE may determine whether to trigger online training. If yes, the process may proceed to 930. If no, the process may proceed to 926.

At 926, the UE may perform offline training of a machine learning model associated with identification of the UE mobility state of the UE based on the wireless physical channel features including the RSRP and/or the NTA (i.e., the same feature set as used at 908). Further, the UE may identify the UE mobility state based on the trained machine learning model.

At 928, the UE may attempt to verify the HST state identified at 922 based on the machine learning model. If the HST state is confirmed, the process may return to 926. If the HST state is rejected as being false, the process may return to 920.

At 930, the UE may train, using online training, a machine learning model based on a flexible wireless physical channel feature set that may be the same as the flexible wireless physical channel feature set used with the HST flagged data. Further, the UE may identify the UE mobility state based on the trained machine learning model. The flexible wireless physical channel feature set may be a dynamic subset of the full feature set (which may include the full feature set itself) (the full feature set may include all features, such as the RSRP, the NTA, the total frequency error, and the PCI change rate) with some features removed from the full feature set in certain scenarios or some features added to the basic feature set in some other scenarios. For example, in an overfitting scenario, features including one or more of the total frequency error or the PCI change rate may be removed from the full feature set. Further, in an underfitting scenario, features and/or exceptions may be added to the basic feature set (e.g., the basic feature set used at 910), where the features added may include one or more of the total frequency error or the PCI change rate.

At 932, the UE may attempt to verify the HST state identified at 922 based on the machine learning model trained at 930. If the HST state is confirmed, the process may return to 930. If the HST state is rejected as being false, the process may return to 920.

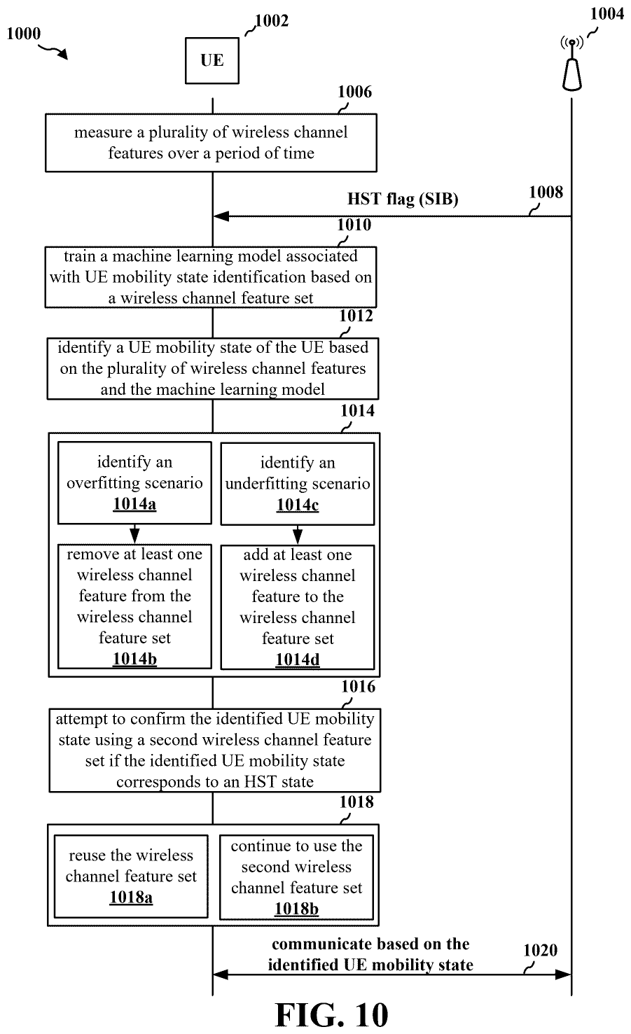

FIG. 10 is a flow diagram 1000 of a method of wireless communication according to one or more aspects. At 1006, the UE 1002 may measure a plurality of wireless channel features over a period of time.

At 1008, the UE 1002 may receive the HST flag from a network node 1004 via a SIB.

At 1010, the UE 1002 may train a machine learning model associated with UE mobility state identification based on a wireless channel feature set. The wireless channel feature set may be based on at least one of a training technique (e.g., online training or offline training) associated with the machine learning model, availability of an HST flag, or an RRC state of the UE.

In one or more configurations, the machine learning model may include at least one of an LSTM, an RNN, or a transformer.

At 1012, the UE 1002 may identify a UE mobility state of the UE based on the plurality of wireless channel features and the machine learning model.

In one or more configurations, the machine learning model may be trained offline. The UE mobility state of the UE may be identified based further on the HST flag. The wireless channel feature set may include at least one of an RSRP or an NTA.

In one or more configurations, the machine learning model may be trained online. The wireless channel feature set may include at least one of an RSRP, an NTA, a total frequency error, or a PCI change rate.

1014 may include 1014a, 1014b, 1014c, and 1014d.

At 1014a, the UE 1002 may identify an overfitting scenario.

At 1014b, the UE 1002 may remove at least one wireless channel feature from the wireless channel feature set in response to identifying, at 1014a, the overfitting scenario.

At 1014c, the UE 1002 may identify an underfitting scenario.

At 1014d, the UE 1002 may add at least one wireless channel feature to the wireless channel feature set in response to identifying, at 1014c, the underfitting scenario.

In one or more configurations, the machine learning model may be trained offline. The HST flag may not be available. The wireless channel feature set may include at least one of an RSRP or a PCI change rate.

At 1016, the UE 1002 may attempt to verify the identified UE mobility state using a second wireless channel feature set if the identified UE mobility state corresponds to an HST state. The second wireless channel feature set may include the wireless channel feature set and at least one of an NTA or a total frequency error. 1018 may include 1018a and 1018b.

At 1018a, if the identified UE mobility state corresponding to the HST state is rejected as being false based on the second wireless channel feature set, the UE 1002 may reuse the wireless channel feature set including at least one of the RSRP or the PCI change rate for further identification of the UE mobility state of the UE.

At 1018b, if the identified UE mobility state corresponding to the HST state is confirmed based on the second wireless channel feature set, the UE 1002 may continue to use the second wireless channel feature set for further identification of the UE mobility state of the UE.

In one or more configurations, the machine learning model may be trained offline. The HST flag may not be available. A time interval between any two consecutive identifications of the UE mobility state of the UE based on the plurality of wireless channel features and the machine learning model may be greater than a threshold.

In one or more configurations, the machine learning model may be trained online. The UE may be in an RRC Idle state. The wireless channel feature set may include a Doppler spread or a delay spread associated with a plurality of network nodes.

At 1020, the UE 1002 may communicate with a network node 1004 based on the identified UE mobility state.

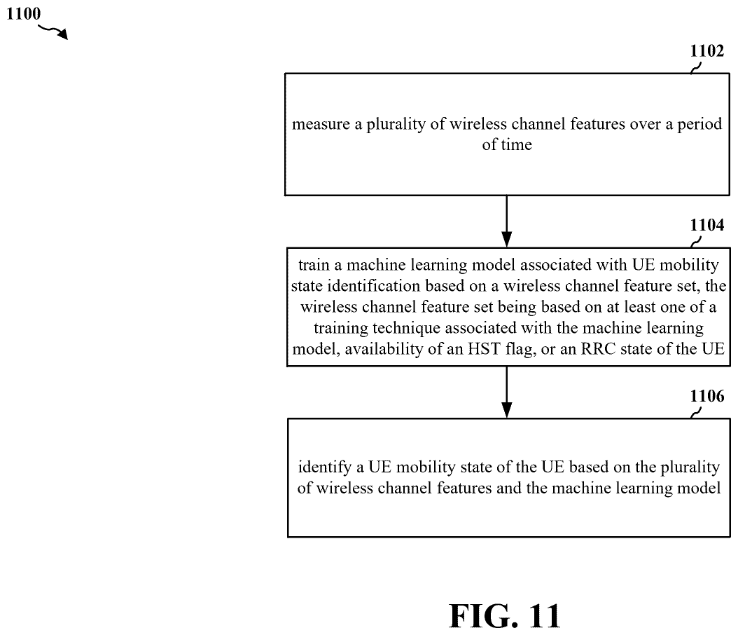

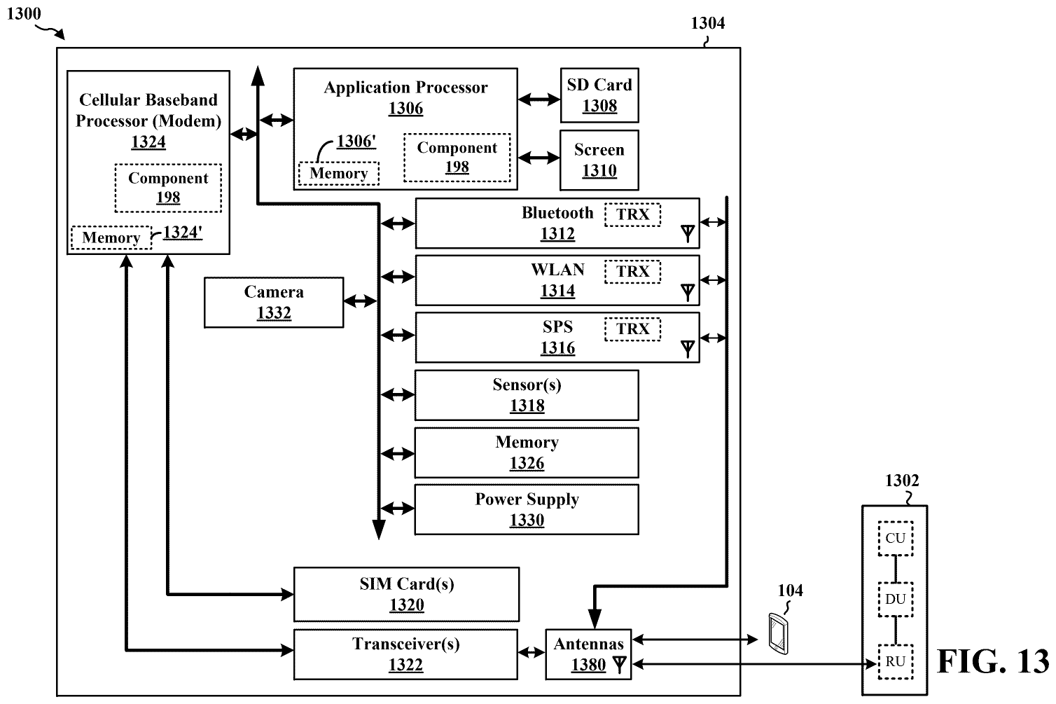

FIG. 11 is a flowchart 1100 of a method of wireless communication. The method may be performed by a UE (e.g., the UE 104/350/1002; the apparatus 1304). At 1102, the UE may measure a plurality of wireless channel features over a period of time. For example, 1102 may be performed by the component 198 in FIG. 13. Referring to FIG. 10, at 1006, the UE 1002 may measure a plurality of wireless channel features over a period of time.

At 1104, the UE may train a machine learning model associated with UE mobility state identification based on a wireless channel feature set. The wireless channel feature set may be based on at least one of a training technique associated with the machine learning model, availability of an HST flag, or an RRC state of the UE. For example, 1104 may be performed by the component 198 in FIG. 13. Referring to FIG. 10, at 1010, the UE 1002 may train a machine learning model associated with UE mobility state identification based on a wireless channel feature set.

At 1106, the UE may identify a UE mobility state of the UE based on the plurality of wireless channel features and the machine learning model. For example, 1106 may be performed by the component 198 in FIG. 13. Referring to FIG. 10, at 1012, the UE 1002 may identify a UE mobility state of the UE based on the plurality of wireless channel features and the machine learning model.

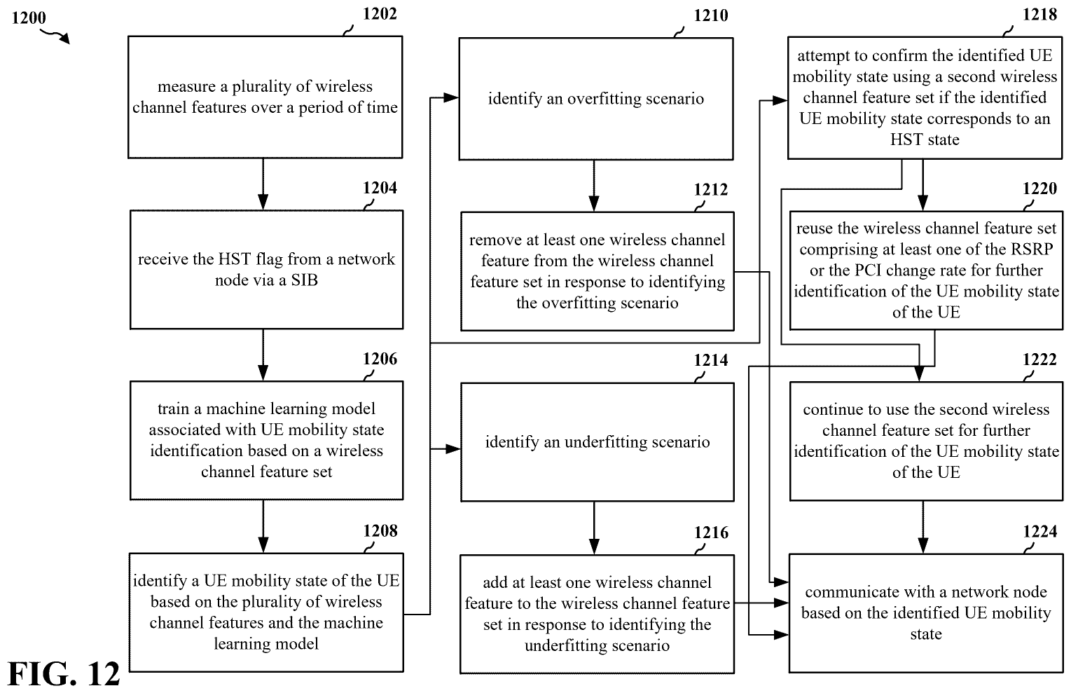

FIG. 12 is a flowchart 1200 of a method of wireless communication. The method may be performed by a UE (e.g., the UE 104/350/1002; the apparatus 1304). At 1202, the UE may measure a plurality of wireless channel features over a period of time. For example, 1202 may be performed by the component 198 in FIG. 13. Referring to FIG. 10, at 1006, the UE 1002 may measure a plurality of wireless channel features over a period of time.

At 1206, the UE may train a machine learning model associated with UE mobility state identification based on a wireless channel feature set. The wireless channel feature set may be based on at least one of a training technique associated with the machine learning model, availability of an HST flag, or an RRC state of the UE. For example, 1206 may be performed by the component 198 in FIG. 13. Referring to FIG. 10, at 1010, the UE 1002 may train a machine learning model associated with UE mobility state identification based on a wireless channel feature set.

At 1208, the UE may identify a UE mobility state of the UE based on the plurality of wireless channel features and the machine learning model. For example, 1208 may be performed by the component 198 in FIG. 13. Referring to FIG. 10, at 1012, the UE 1002 may identify a UE mobility state of the UE based on the plurality of wireless channel features and the machine learning model.

In one configuration, the machine learning model may include at least one of an LSTM, an RNN, or a transformer.

In one configuration, the machine learning model may be trained offline. The UE mobility state of the UE may be identified based further on the HST flag. The wireless channel feature set may include at least one of an RSRP or an NTA.

In one configuration, at 1204, the UE may receive the HST flag from a network node via a SIB. For example, 1204 may be performed by the component 198 in FIG. 13. Referring to FIG. 10, at 1008, the UE 1002 may receive the HST flag from a network node 1004 via a SIB.

In one configuration, the machine learning model may be trained online. The wireless channel feature set may include at least one of an RSRP, an NTA, a total frequency error, or a PCI change rate.

In one configuration, at 1210, the UE may identify an overfitting scenario. For example, 1210 may be performed by the component 198 in FIG. 13. Referring to FIG. 10, at 1014a, the UE 1002 may identify an overfitting scenario.

At 1212, the UE may remove at least one wireless channel feature from the wireless channel feature set in response to identifying the overfitting scenario. For example, 1212 may be performed by the component 198 in FIG. 13. Referring to FIG. 10, at 1014b, the UE 1002 may remove at least one wireless channel feature from the wireless channel feature set in response to identifying, at 1014a, the overfitting scenario.

In one configuration, at 1214, the UE may identify an underfitting scenario. For example, 1214 may be performed by the component 198 in FIG. 13. Referring to FIG. 10, at 1014c, the UE 1002 may identify an underfitting scenario.

At 1216, the UE may add at least one wireless channel feature to the wireless channel feature set in response to identifying the underfitting scenario. For example, 1216 may be performed by the component 198 in FIG. 13. Referring to FIG. 10, at 1014d, the UE 1002 may add at least one wireless channel feature to the wireless channel feature set in response to identifying, at 1014c, the underfitting scenario.

In one configuration, the machine learning model may be trained offline. The HST flag may not be available. The wireless channel feature set may include at least one of an RSRP or a PCI change rate.

In one configuration, at 1218, the UE may attempt to verify the identified UE mobility state using a second wireless channel feature set if the identified UE mobility state corresponds to an HST state. The second wireless channel feature set may include the wireless channel feature set and at least one of an NTA or a total frequency error. For example, 1218 may be performed by the component 198 in FIG. 13. Referring to FIG. 10, at 1016, the UE 1002 may attempt to verify the identified UE mobility state using a second wireless channel feature set if the identified UE mobility state corresponds to an HST state.

In one configuration, at 1220, if the identified UE mobility state corresponding to the HST state is rejected as being false based on the second wireless channel feature set, the UE may reuse the wireless channel feature set including at least one of the RSRP or the PCI change rate for further identification of the UE mobility state of the UE. For example, 1220 may be performed by the component 198 in FIG. 13. Referring to FIG. 10, at 1018a, if the identified UE mobility state corresponding to the HST state is rejected as being false based on the second wireless channel feature set, the UE 1002 may reuse the wireless channel feature set including at least one of the RSRP or the PCI change rate for further identification of the UE mobility state of the UE.

In one configuration, at 1222, if the identified UE mobility state corresponding to the HST state is confirmed based on the second wireless channel feature set, the UE may continue to use the second wireless channel feature set for further identification of the UE mobility state of the UE. For example, 1222 may be performed by the component 198 in FIG. 13. Referring to FIG. 10, at 1018b, if the identified UE mobility state corresponding to the HST state is confirmed based on the second wireless channel feature set, the UE 1002 may continue to use the second wireless channel feature set for further identification of the UE mobility state of the UE.

In one configuration, the machine learning model may be trained offline. The HST flag may not be available. A time interval between any two consecutive identifications of the UE mobility state of the UE based on the plurality of wireless channel features and the machine learning model may be greater than a threshold.

In one configuration, the machine learning model may be trained online. The UE may be in an RRC Idle state. The wireless channel feature set may include a Doppler spread or a delay spread associated with a plurality of network nodes.

In one configuration, at 1224, the UE may communicate with a network node based on the identified UE mobility state. For example, 1224 may be performed by the component 198 in FIG. 13. Referring to FIG. 10, at 1020, the UE 1002 may communicate with a network node 1004 based on the identified UE mobility state.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the component 198 is configured to measure a plurality of wireless channel features over a period of time. The component 198 is further configured to train a machine learning model associated with UE mobility state identification based on a wireless channel feature set. The wireless channel feature set may be based on at least one of a training technique associated with the machine learning model, availability of an HST flag, or an RRC state of the UE. The component 198 is further configured to identify a UE mobility state of the UE based on the plurality of wireless channel features and the machine learning model. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for measuring a plurality of wireless channel features over a period of time. The apparatus 1304, and in particular the cellular baseband processor 1324 and/or the application processor 1306, includes means for training a machine learning model associated with UE mobility state identification based on a wireless channel feature set. The wireless channel feature set may be based on at least one of a training technique associated with the machine learning model, availability of an HST flag, or an RRC state of the UE. The apparatus 1304, and in particular the cellular baseband processor 1324 and/or the application processor 1306, includes means for identifying a UE mobility state of the UE based on the plurality of wireless channel features and the machine learning model.

In one configuration, the machine learning model may include at least one of an LSTM, an RNN, or a transformer. In one configuration, the machine learning model may be trained offline. The UE mobility state of the UE may be identified based further on the HST flag. The wireless channel feature set may include at least one of an RSRP or an NTA. In one configuration, the apparatus 1304, and in particular the cellular baseband processor 1324 and/or the application processor 1306, includes means for receiving the HST flag from a network node via a SIB. In one configuration, the machine learning model may be trained online. The wireless channel feature set may include at least one of an RSRP, an NTA, a total frequency error, or a PCI change rate. In one configuration, the apparatus 1304, and in particular the cellular baseband processor 1324 and/or the application processor 1306, includes means for identifying an overfitting scenario; and means for removing at least one wireless channel feature from the wireless channel feature set in response to identifying the overfitting scenario. In one configuration, the apparatus 1304, and in particular the cellular baseband processor 1324 and/or the application processor 1306, includes means for identifying an underfitting scenario; and means for adding at least one wireless channel feature to the wireless channel feature set in response to identifying the underfitting scenario. In one configuration, the machine learning model may be trained offline. The HST flag may not be available. The wireless channel feature set may include at least one of an RSRP or a PCI change rate. In one configuration, the apparatus 1304, and in particular the cellular baseband processor 1324 and/or the application processor 1306, includes means for attempting to verify the identified UE mobility state using a second wireless channel feature set if the identified UE mobility state corresponds to an HST state. The second wireless channel feature set may include the wireless channel feature set and at least one of an NTA or a total frequency error. In one configuration, if the identified UE mobility state corresponding to the HST state is rejected as being false based on the second wireless channel feature set, the apparatus 1304, and in particular the cellular baseband processor 1324 and/or the application processor 1306, includes means for reusing the wireless channel feature set including at least one of the RSRP or the PCI change rate for further identification of the UE mobility state of the UE. In one configuration, if the identified UE mobility state corresponding to the HST state is confirmed based on the second wireless channel feature set, the apparatus 1304, and in particular the cellular baseband processor 1324 and/or the application processor 1306, includes means for continuing to use the second wireless channel feature set for further identification of the UE mobility state of the UE. In one configuration, the machine learning model may be trained offline. The HST flag may not be available. A time interval between any two consecutive identifications of the UE mobility state of the UE based on the plurality of wireless channel features and the machine learning model may be greater than a threshold. In one configuration, the machine learning model may be trained online. The UE may be in an RRC Idle state. The wireless channel feature set may include a Doppler spread or a delay spread associated with a plurality of network nodes. In one configuration, the apparatus 1304, and in particular the cellular baseband processor 1324 and/or the application processor 1306, includes means for communicating with a network node based on the identified UE mobility state.

The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

Referring back to FIGS. 4-13, a UE may measure a plurality of wireless channel features over a period of time. The UE may train a machine learning model associated with UE mobility state identification based on a wireless channel feature set. The wireless channel feature set may be based on at least one of a training technique associated with the machine learning model, availability of an HST flag, or an RRC state of the UE. The UE may identify a UE mobility state of the UE based on the plurality of wireless channel features and the machine learning model. Accordingly, suitable wireless physical channel feature sets may be selected under different scenarios to achieve an appropriate balance between machine learning model complexity, training overhead, and detection accuracy.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including measuring a plurality of wireless channel features over a period of time; training a machine learning model associated with UE mobility state identification based on a wireless channel feature set, the wireless channel feature set being based on at least one of a training technique associated with the machine learning model, availability of an HST flag, or an RRC state of the UE; and identifying a UE mobility state of the UE based on the plurality of wireless channel features and the machine learning model.

Aspect 2 is the method of aspect 1, where the machine learning model includes at least one of an LSTM, an RNN, or a transformer.

Aspect 3 is the method of any of aspects 1 and 2, where the machine learning model is trained offline, the UE mobility state of the UE is identified based further on the HST flag, and the wireless channel feature set includes at least one of an RSRP or an NTA.

Aspect 4 is the method of aspect 3, further including: receiving the HST flag from a network node via a SIB.

Aspect 5 is the method of any of aspects 1 and 2, where the machine learning model is trained online, and the wireless channel feature set includes at least one of an RSRP, an NTA, a total frequency error, or a PCI change rate.

Aspect 6 is the method of aspect 5, further including: identifying an overfitting scenario; and removing at least one wireless channel feature from the wireless channel feature set in response to identifying the overfitting scenario.

Aspect 7 is the method of aspect 5, further including: identifying an underfitting scenario; and adding at least one wireless channel feature to the wireless channel feature set in response to identifying the underfitting scenario.

Aspect 8 is the method of any of aspects 1 and 2, where the machine learning model is trained offline, the HST flag is not available, and the wireless channel feature set includes at least one of an RSRP or a PCI change rate.

Aspect 9 is the method of aspect 8, further including: attempting to verify the identified UE mobility state using a second wireless channel feature set if the identified UE mobility state corresponds to an HST state, the second wireless channel feature set including the wireless channel feature set and at least one of an NTA or a total frequency error.

Aspect 10 is the method of aspect 9, where if the identified UE mobility state corresponding to the HST state is rejected as being false based on the second wireless channel feature set, the method further comprises: reusing the wireless channel feature set including at least one of the RSRP or the PCI change rate for further identification of the UE mobility state of the UE.

Aspect 11 is the method of aspect 9, where if the identified UE mobility state corresponding to the HST state is confirmed based on the second wireless channel feature set, the method further includes: continuing to use the second wireless channel feature set for further identification of the UE mobility state of the UE.

Aspect 12 is the method of any of aspects 1 and 2, where the machine learning model is trained offline, the HST flag is not available, and a time interval between any two consecutive identifications of the UE mobility state of the UE based on the plurality of wireless channel features and the machine learning model is greater than a threshold.

Aspect 13 is the method of any of aspects 1 and 2, where the machine learning model is trained online, the UE is in an RRC Idle state, and the wireless channel feature set includes a Doppler spread or a delay spread associated with a plurality of network nodes.

Aspect 14 is the method of any of aspects 1 and 13, further including: communicating with a network node based on the identified UE mobility state.

What is claimed is:

1. An apparatus for wireless communication at a user equipment (UE), comprising:
a memory; and
at least one processor coupled to the memory and, based at least in part on information stored in the memory, the at least one processor is configured to:
measure a plurality of wireless channel features over a period of time;
train a machine learning model associated with UE mobility state identification based on a wireless channel feature set, the wireless channel feature set being based on at least one of a training technique associated with the machine learning model, availability of a high-speed train (HST) flag, or a radio resource control (RRC) state of the UE; and
identify a UE mobility state of the UE based on the plurality of wireless channel features and the machine learning model.

2. The apparatus of claim 1, wherein the machine learning model comprises at least one of a long short-term memory (LSTM), a recurrent neural network (RNN), or a transformer.

3. The apparatus of claim 1, wherein the machine learning model is trained offline, the UE mobility state of the UE is identified based further on the HST flag, and the wireless channel feature set comprises at least one of a reference signal receiver power (RSRP) or a network time advance (NTA).

4. The apparatus of claim 3, the at least one processor being further configured to:
receive the HST flag from a network node via a system information block (SIB).

5. The apparatus of claim 1, wherein the machine learning model is trained online, and the wireless channel feature set comprises at least one of a reference signal receiver power (RSRP), a network time advance (NTA), a total frequency error, or a physical cell identifier (PCI) change rate.

6. The apparatus of claim 5, the at least one processor being further configured to:
identify an overfitting scenario; and
remove at least one wireless channel feature from the wireless channel feature set in response to identifying the overfitting scenario.

7. The apparatus of claim 5, the at least one processor being further configured to:
identify an underfitting scenario; and
add at least one wireless channel feature to the wireless channel feature set in response to identifying the underfitting scenario.

8. The apparatus of claim 1, wherein the machine learning model is trained offline, the HST flag is not available, and the wireless channel feature set comprises at least one of a reference signal receiver power (RSRP) or a physical cell identifier (PCI) change rate.

9. The apparatus of claim 8, the at least one processor being further configured to:
attempt to verify the identified UE mobility state using a second wireless channel feature set if the identified UE mobility state corresponds to an HST state, the second wireless channel feature set comprising the wireless channel feature set and at least one of a network time advance (NTA) or a total frequency error.

10. The apparatus of claim 9, wherein if the identified UE mobility state corresponding to the HST state is rejected as being false based on the second wireless channel feature set, the at least one processor is further configured to:
reuse the wireless channel feature set comprising at least one of the RSRP or the PCI change rate for further identification of the UE mobility state of the UE.

11. The apparatus of claim 9, wherein if the identified UE mobility state corresponding to the HST state is confirmed based on the second wireless channel feature set, the at least one processor is further configured to:
continue to use the second wireless channel feature set for further identification of the UE mobility state of the UE.

12. The apparatus of claim 1, wherein the machine learning model is trained offline, the HST flag is not available, and a time interval between any two consecutive identifications of the UE mobility state of the UE based on the plurality of wireless channel features and the machine learning model is greater than a threshold.

13. The apparatus of claim 1, wherein the machine learning model is trained online, the UE is in an RRC Idle state, and the wireless channel feature set comprises a Doppler spread or a delay spread associated with a plurality of network nodes.

14. The apparatus of claim 1, the at least one processor being further configured to:
communicate with a network node based on the identified UE mobility state.

15. The apparatus of claim 1, further comprising a transceiver coupled to the at least one processor.

16. A method of wireless communication at a user equipment (UE), comprising:
measuring a plurality of wireless channel features over a period of time;
training a machine learning model associated with UE mobility state identification based on a wireless channel feature set, the wireless channel feature set being based on at least one of a training technique associated with the machine learning model, availability of a high-speed train (HST) flag, or a radio resource control (RRC) state of the UE; and
identifying a UE mobility state of the UE based on the plurality of wireless channel features and the machine learning model.

17. The method of claim 16, wherein the machine learning model comprises at least one of a long short-term memory (LSTM), a recurrent neural network (RNN), or a transformer.

18. The method of claim 16, wherein the machine learning model is trained offline, the UE mobility state of the UE is identified based further on the HST flag, and the wireless channel feature set comprises at least one of a reference signal receiver power (RSRP) or a network time advance (NTA).

19. The method of claim 18, further comprising:
receiving the HST flag from a network node via a system information block (SIB).

20. The method of claim 16, wherein the machine learning model is trained online, and the wireless channel feature set comprises at least one of a reference signal receiver power (RSRP), a network time advance (NTA), a total frequency error, or a physical cell identifier (PCI) change rate.

21. The method of claim 20, further comprising:
identifying an overfitting scenario; and
removing at least one wireless channel feature from the wireless channel feature set in response to identifying the overfitting scenario.

22. The method of claim 20, further comprising:
identifying an underfitting scenario; and
adding at least one wireless channel feature to the wireless channel feature set in response to identifying the underfitting scenario.

23. The method of claim 16, wherein the machine learning model is trained offline, the HST flag is not available, and the wireless channel feature set comprises at least one of a reference signal receiver power (RSRP) or a physical cell identifier (PCI) change rate.

24. The method of claim 23, further comprising:
attempting to verify the identified UE mobility state using a second wireless channel feature set if the identified UE mobility state corresponds to an HST state, the second wireless channel feature set comprising the wireless channel feature set and at least one of a network time advance (NTA) or a total frequency error.

25. The method of claim 24, wherein if the identified UE mobility state corresponding to the HST state is rejected as being false based on the second wireless channel feature set, the method further comprises:
reusing the wireless channel feature set comprising at least one of the RSRP or the PCI change rate for further identification of the UE mobility state of the UE.

26. The method of claim 24, wherein if the identified UE mobility state corresponding to the HST state is confirmed based on the second wireless channel feature set, the method further comprises:
continuing to use the second wireless channel feature set for further identification of the UE mobility state of the UE.

27. The method of claim 16, wherein the machine learning model is trained offline, the HST flag is not available, and a time interval between any two consecutive identifications of the UE mobility state of the UE based on the plurality of wireless channel features and the machine learning model is greater than a threshold.

28. The method of claim 16, wherein the machine learning model is trained online, the UE is in an RRC Idle state, and the wireless channel feature set comprises a Doppler spread or a delay spread associated with a plurality of network nodes.

29. An apparatus for wireless communication at a user equipment (UE), comprising:
means for measuring a plurality of wireless channel features over a period of time;
means for training a machine learning model associated with UE mobility state identification based on a wireless channel feature set, the wireless channel feature set being based on at least one of a training technique associated with the machine learning model, availability of a high-speed train (HST) flag, or a radio resource control (RRC) state of the UE; and
means for identifying a UE mobility state of the UE based on the plurality of wireless channel features and the machine learning model.

30. A computer-readable medium storing computer executable code at a user equipment (UE), the code when executed by a processor causes the processor to:
measure a plurality of wireless channel features over a period of time;
train a machine learning model associated with UE mobility state identification based on a wireless channel feature set, the wireless channel feature set being based on at least one of a training technique associated with the machine learning model, availability of a high-speed train (HST) flag, or a radio resource control (RRC) state of the UE; and
identify a UE mobility state of the UE based on the plurality of wireless channel features and the machine learning model.
